(19) United States
(12) Patent Application Publication
(10) Pub. No.: US 2015/0206157 A1
(43) Pub. Date: Jul. 23, 2015

(54) METHODS AND SYSTEMS FOR ESTIMATING CUSTOMER EXPERIENCE

(71) Applicant: Wipro Limited, Bangalore (IN)

(72) Inventors: Vijay Rao Perepa, Hyderabad (IN); Venkatakrishnan Rajaram, Bangalore (IN)

(73) Assignee: Wipro Limited, Bangalore (IN)

(21) Appl. No.: 14/196,362

(22) Filed: Mar. 4, 2014

(30) Foreign Application Priority Data
Jan. 18, 2014 (IN) 214/CHE/2014

(51) Int. Cl. G06Q 30/02

(52) U.S. Cl. CPC G06Q 30/0203

(57) ABSTRACT

This disclosure relates to methods and systems for estimating customer experience, the method comprising: receiving one or more interaction parameters associated with an interaction between the utility providing entity and a customer entity; determining, by a hardware processor in communication with the utility providing entity, a first interaction score based on the received one or more interaction parameters; determining a second interaction score based on the first interaction score and a feedback rating, provided by the customer entity, associated with the interaction; determining a third interaction score based on the second interaction score and a time interval between the interaction and a previous interaction between the utility providing entity and the customer entity; determining a customer experience score associated with the interaction based on the third interaction score and a stored customer experience score associated with the previous interaction; and providing the customer experience score.

This application claims the benefit of Indian Patent Application Filing Number 214/CHE/2014, filed on Jan. 18, 2014, which is hereby incorporated by reference in its entirety.

### FIELD

This disclosure relates generally to water utility entities, and more particularly to methods and systems for estimating customer experience by a water utility entity.

### BACKGROUND

Providing satisfactory services to customers is a vital aspect for water utility providing entities. Water utility providing entities provide various services related to water supply such as infrastructure maintenance (pipelines, sewage infrastructure etc.), billing issues, complaints, resolutions to customer queries etc. to customers. Generally, a water utility entity attempts to gather customer feedback by conducting feedback surveys or personal interviews, receiving answers to questionnaire from customers, or receiving telephonic feedback. Customer feedback, thus gathered, enables a water utility to provide better services to its customers.

Therefore, there is a need for a water utility to achieve greater accuracy in estimating customer experience in order to provide satisfactory services to its customers.

### SUMMARY

In one embodiment, a method performed by a utility providing entity for estimating customer experience is disclosed, the method comprising: receiving one or more interaction parameters associated with an interaction between the utility providing entity and a customer entity; determining, by a hardware processor in communication with the utility providing entity, a first interaction score based on the received one or more interaction parameters; determining a second interaction score based on the first interaction score and a feedback rating, provided by the customer entity, associated with the interaction; determining a third interaction score based on the second interaction score and a time interval between the interaction and a previous interaction between the utility providing entity and the customer entity; determining a customer experience score associated with the interaction based on the second interaction score and a stored customer experience score associated with the previous interaction; and providing the customer experience score.

In one embodiment, a utility providing apparatus for estimating customer experience is disclosed, the apparatus comprising: at least one hardware processor; and a memory including instructions executable by the at least one hardware processor, wherein the instructions configure the at least one hardware processor to: receive one or more interaction parameters associated with an interaction between the utility providing apparatus and a customer entity; determine a first interaction score based on the received one or more interaction parameters; determine a second interaction score based on the first interaction score and a feedback rating, provided by the customer entity, associated with the interaction; determine a third interaction score based on the second interaction score and a time interval between the interaction and a previous interaction between the utility providing entity and the customer entity; determine a customer experience score associated with the interaction based on the second interaction score and a stored customer experience score associated with the previous interaction; and provide the customer experience score.

In one embodiment, a non-transitory computer readable medium storing computer executable instructions is disclosed, the instructions when executed by a hardware processor, cause the processor to perform operations comprising: receiving one or more interaction parameters associated with an interaction between a utility providing entity and a customer entity; determining, by the hardware processor, a first interaction score based on the received one or more interaction parameters; determining a second interaction score based on the first interaction score and a feedback rating, provided by the customer entity, associated with the interaction; determining a third interaction score based on the second interaction score and a time interval between the interaction and a previous interaction between the utility providing entity and the customer entity; determining a customer experience score associated with the interaction based on the second interaction score and a stored customer experience score associated with the previous interaction; and providing the customer experience score.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an environment in which a water utility interacts with customer entities in accordance with some embodiments.

FIG. 2 illustrates a flowchart for determining a customer experience score in accordance with some embodiments.

FIG. 3 illustrates an elementary block diagram of a water utility entity in accordance with some embodiments.

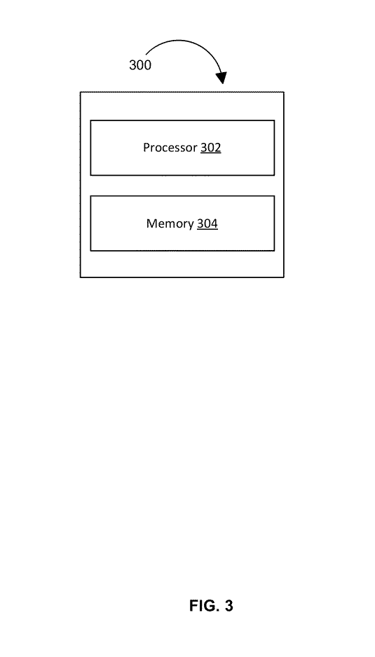

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

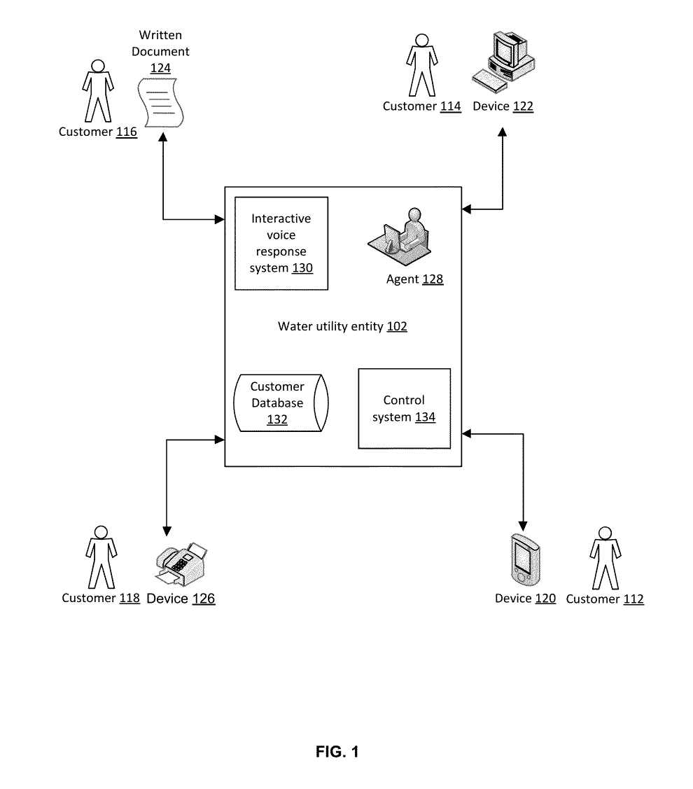

FIG. 1 illustrates an environment in which a water utility entity interacts with various customer entities in accordance with some embodiments. A water utility entity 102 as illustrated in FIG. 1 may interact with various customer entities that receive water utility services from water utility entity 102. For purposes of this disclosure, a customer entity may include a single customer who receives water utility services from water utility entity 102. It should be understood, however, that a customer entity may also include a group of customers such as an organization, a company, or a household associated that interacts with water utility entity 102. It should also be understood that in some embodiments, a customer entity may include a customer and a device that the customer uses to interact with a water utility entity 102. The terms customer and customer entity will be used interchangeably in this disclosure. A customer entity may interact with water utility entity 102 to request for a water utility service, to modify an existing service, request resolution to an issue or an answer to a query, register a complaint, billing issues, and/or provide feedback regarding the services provided by water utility entity 102. The interaction between a particular customer and water utility entity 102 may occur in the form of personal interviews, emails, instant messages or short message service (SMS), voice or video calling, through a website associated with water utility entity 102, or facsimile.

In some embodiments, water utility entity 102 may interact with various customers such as customer 112, customer 114, customer 116, and customer 118 and vice versa. For exemplary purposes, FIG. 1 illustrates that customer 112 may interact with water utility entity 102 by using a device 120. Device 120 may be a mobile device, a handheld device, a tablet, or any other electronic device that is capable of conducting audio and/or video calling with an agent 128 associated with water utility entity 102, interacting with an interactive voice response (IVR) response system 130 associated with water utility entity 102, sending SMS, running an interne browsing functionality and/or sending electronic mails (e-mail) to water utility entity 102. Further, another customer 114 may communicate with water utility entity 102 by using a device 122. Device 122 may include a desktop computer, a workstation, a laptop, or a tablet personal computer (PC). Device 122 may be capable of sending emails and/or instant messages, conducting a video call or an audio call, and/or running an internet browsing functionality to browse and/or provide inputs to a website associated with water utility entity 102.

Further, customer 116 may interact with water utility entity 102 by providing a written feedback 124. Written feedback 124 may be provided on a document that includes a questionnaire, in some embodiments. It should be apparent to a person skilled in the art, however, that written feedback 124 may also include suggestions, performance rating, complaints, or any other content that a customer intends to communicate to water utility 102. For example, customer 116 may provide a rating to various services provided by or interactions with water utility entity 102 in written feedback 124. In some embodiments, written feedback 124 may be manually delivered to water utility entity 102. Alternately, written feedback 124 may be scanned and a scanned image may be sent to water utility 102 by using device 120 or device 122 or any other electronic device capable of scanning a document. Further, customer 118 may use a device 126 to send a facsimile to water utility entity 102. Device 126 may include a facsimile machine that is used to send a facsimile of a written document such as written feedback 124 or a similar document, to water utility entity 102.

Water utility 102 may, apart from agent 128 and IVR system 130, further include a customer database 132. Customer database 132 may maintain a record of customer contacts, customer feedback, details of various services offered to customers, or any other information that water utility 102 requires for its operations. In addition, water utility 102 may include a control system 134 that may control any processing operations performed by water utility 102. For example, control system 134 may perform processing activities related to execution of various instructions to provide services, perform operations related to IVR system 130, store information in customer database 134, or any other processing activities required to be performed by water utility 102 to maintain its operations.

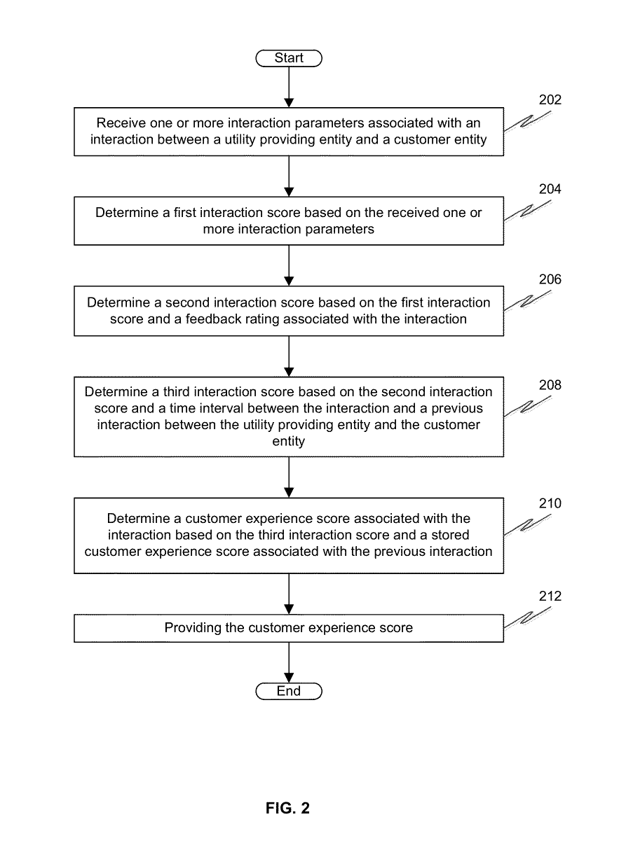

A method for determining a customer experience score will now be explained in accordance with some embodiments of this disclosure. The method may be performed by a water utility entity such as that illustrated in the context of FIG. 1. Further, FIG. 2 illustrates a flowchart for determining a customer experience score associated with a customer in accordance with some embodiments.

In step 202, a processor in communication with the water utility entity, may receive one or more interaction parameters associated with an interaction between a utility providing entity and a customer entity. Here, a customer entity may include a customer, a group of customers, or a customer and a device that the customer uses to interact with the water utility entity. For purposes of this disclosure, the terms customer and customer entity are interchangeably used. In some embodiments, a customer may interact with the water utility for various purposes such as to request for a new service, a modification to an already availed service, billing issues, complaints and other similar purposes. Further, the customer may converse with an agent in a call center associated with the water utility entity, interact with an IVR system associated with the water utility, or follow any other means of interaction as specified in the context of FIG. 1. The customer may additionally provide a feedback indicating a performance rating as to how well the interaction was handled by the water utility entity.

Once the interaction has occurred, a call center agent may determine one or more interaction parameters associated with the interaction. This determination may be based on various sample values of these interaction parameters that are predefined and stored in a memory of the water utility entity. These interaction parameters may include an interaction category associated with the interaction, an interaction sub-category associated with an interaction, and an interaction mode associated with the interaction. In some embodiments, an interaction category associated with the interaction may broadly indicate a context of the interaction. Various types of interactions may be grouped according to different interaction categories. For example, some of the interaction categories that are defined by the water utility entity may include billing and charging, waste water issues, water operations, meter issues, procedural issues (change of address etc.). Each of these interaction categories encompasses multiple types of interactions that have different specific purposes but can be grouped under one broad context. Here, billing and charging may include any interaction that relates to billing and charging issues. It may include interactions with specific purposes such as a complaint regarding billing issues, an enquiry regarding an outstanding amount, a request for online payment facility etc. Similarly, procedural issues may include any interaction related to know-how of a procedure such as a customer query regarding the customer's address change in the records of the water utility entity, procedure to install a new water pipeline in a household etc. The other interaction categories may similarly include multiple interactions depending on the specific purpose the interactions are related to.

Further, an interaction sub-category may indicate whether the interaction includes a complaint or a request by the customer. For example, an interaction regarding leakage of water in a pipeline may be classified as a complaint but an interaction from a household for requesting a new water connection may be classified as a request. Similarly, all the interactions may classified by the call center agent as either a complaint or a request. Furthermore, an interaction mode may indicate a means of communication associated with the interaction between the customer and the water utility entity. For example, the interaction mode may be telephonic, written, or any other mode through with the interaction may occur.

The call center agent, on analyzing an interaction, may determine one or more interaction parameters associated with the interaction. This may include selecting an interaction category from the stored interaction categories and classifying the interaction according to that interaction category based on the specific purpose of the interaction. For example, a billing problem may be classified under the interaction category: billing and charging. Similarly, an interaction including a query regarding a meter may be classified under the interaction category: meter issues and so on. The call center agent may similarly select an interaction sub-category from the stored interaction sub-categories and an interaction mode from the stored interaction modes and assign these interaction parameters to the interaction.

In another exemplary scenario, a customer may call a water utility entity to complain about an online payment failure for a water bill. In this case, the call center agent may assign the interaction category: billing and charging, the interaction sub-category: complaint and the interaction mode: telephonic, to this interaction. A call center agent may assign these values to any other interactions that occur, in a similar manner as discussed. Once the interaction parameters for an interaction are determined, the call center agent may provide these interaction parameters to the processor for further processing. In some embodiments, this information may be provided to the processor individually for each interaction. In some embodiments, however, a list of all the interactions over a period of time may be created, along with their respective interaction parameters and provided to the processor for further processing. This list may be created by the call center agent if there are a large number of interactions over a small period of time. An exemplary list of such interactions along with their respective interaction parameters is illustrated in table 1 below.

TABLE 1
Exemplary list of various interactions their interaction parameters.

| | | Interaction | |
|---|---|---|---|
| | Interaction | sub- | Interaction |
| Interaction description | category | category | mode |
| Billing Response problem | Billing and | Complaint | Telephonic |
| | Charging | | |
| Sewage flooding - external | Waste water | Complaint | Written |
| | issues | | |
| Low water pressure | Water operations | Complaint | Telephonic |
| | issues | | |
| Query regarding meter | Meter issues | Enquiry | Telephonic |
| Query regarding address | Procedural issues | Enquiry | Telephonic |
| change | | | |
| Interaction regarding other | Other issues | Enquiry | Written |
| contexts | | | |

It should be apparent that the interactions illustrated in table 1 are for exemplary purposes only and interactions of various types and categories that are not necessarily shown in table 1 may also occur. Moreover, an interaction category may include various types of interactions that are related to different specific purposes but broadly classified under the context of the interaction category.

In step 204, the processor may determine a first interaction score based on the received one or more interaction parameters that are associated with an interaction. In some embodiments, this interaction score is called a basic interaction score for an interaction and may be determined based on one or more of the interaction parameters: the interaction category, the interaction sub-category, and the interaction mode associated with the interaction.

Various sample values of basic interaction score may have been stored in the memory for different combinations of all the interaction parameters. These sample values may have been previously assigned and stored by experts based on various combinations of values of each interaction parameter. For example, for an interaction regarding a billing response problem, having interaction category: billing and charging, interaction sub-category: complaint and an interaction mode: telephonic, the stored sample value of basic interaction score may be 2.55. Further, for an interaction regarding low water pressure, having interaction category: water operations, interaction sub-category: complaint and an interaction mode: telephonic, the stored sample value of the basic interaction score may be 2.75. Table 2 below shows an exemplary list of various stored sample values of basic interaction score depending upon the combination of interaction parameters. Table 2 may be stored in the memory such that the processor can refer to these sample values when determining the basic interaction score for an interaction.

TABLE 2
Basic interaction score for various combinations of interaction parameters

| | | Interaction | | Basic |
|---|---|---|---|---|
| Specific purpose of | Interaction | sub- | Interaction | interaction |
| interaction | category | category | mode | score |
| Billing Response problem | Billing and | Complaint | Telephonic | 2.55 |
| | Charging | | | |
| Sewage flooding - external | Waste water issues | Complaint | Written | 1 |
| Low water pressure | Water operations | Complaint | Telephonic | 1.75 |
| | issues | | | |
| Query regarding meter | Meter issues | Enquiry | Telephonic | 3.1 |
| Query regarding address | Procedural issues | Enquiry | Telephonic | 4 |
| change | | | | |
| Interaction regarding other | Other issues | Enquiry | Written | 2.5 |
| contexts | | | | |

Thus, depending on what value each interaction parameter takes the basic interaction score may vary for each interaction. In some embodiments, the interaction parameters also include the specific purpose of an interaction. Thus, the basic interaction score may be different for interactions that have similar interaction parameters category, sub-category, and mode but include different specific purposes. For example, a telephonic complaint regarding a wrongly delivered bill and a telephonic complaint regarding an online payment failure may have different basic interaction score in spite of having similar category, sub-category, and mode. This is because the specific purpose of the both the interactions are different from each other, which leads to different basic interaction score for both the interactions. In some embodiments, the specific purpose of an interaction may also be indicated by a code defined as per standard practices of a water utility providing entity. These codes may have been assigned by the call center agent at the time of providing the interaction parameters to the processor.

It should be apparent to a person skilled in the art that the sample values used table 2 are used for exemplary purposes only and can vary in different utility providing entities. Further, the stored sample values may be more or less than the specified values in table 2 depending upon how many values are defined and stored in the memory.

Once the processor has received the interaction parameters for an interaction, the processor may look up for a basic interaction score for that combination by using table 2. For example, in case of a billing response problem having interaction category: billing and charging, interaction sub-category: complaint and interaction mode: telephonic, the processor may match this combination with a combination of interaction parameters in table 2. Since the sample value for the matching combination is 2.55, the processor may determine that the basic interaction score for this interaction is 2.55.

It is also possible that a match is not found between the combination of interaction parameters for an interaction and a combination of interaction parameters in table 2. This problem may occur if the combination of interaction parameters has not already been stored in table 2. In this scenario, the processor may, assign a default predetermined value of the basic interaction score to the interaction. For example, if the processor is unable to determine a basic interaction score for an interaction by using table 2 (because a corresponding combination of interaction parameters is not found in table 2), the processor may assign a basic interaction score: 4 to that interaction.

Once the first interaction score (basic interaction score) is determined for an interaction, the processor may determine a second interaction score based on the first interaction score and a feedback rating associated with the interaction, in step 206. The second interaction score may be determined based on a weighted summation of the first interaction score and a feedback rating, according to the feedback weightage. Here, the feedback weightage defines the weight of both the first interaction score and the feedback rating while summing them with each other. In some embodiments, the second interaction score for an interaction may be calculated by using the mathematical formula:

Second interaction score=[x%*(first interaction score)]+[y%*(feedback rating)]

In this formula, x and y are two components that may be defined as a percentage of 100. The values of x and y depend on an interaction category of an interaction for which the second interaction score is being calculated. For example, for an interaction category, billing and charging, x=70 and y=30. The values of x and y for various categories are depicted in table 3 below:

TABLE 3
Feedback weightage values for different interaction categories

| Interaction category | Value of x | Value of y |
|---|---|---|
| Billing and Charging | 70 | 30 |
| Waste water issues | 60 | 40 |
| Water operations issues | 50 | 50 |
| Meter issues | 50 | 50 |
| Procedural issues | 50 | 50 |
| Other issues | 55 | 45 |

Further, the feedback rating may be determined by using a feedback from the customer, with whom the interaction occurred. A customer may provide a feedback regarding how the interaction was handled by a call center. The feedback may be in the form of a questionnaire or any other known formats and may be provided by using any method as discussed in the context of FIG. 1. The customer may provide, in the feedback, an overall rating based on the customer's perception of the performance of the call center agent in handling the interaction. For example, the rating may be out of 5, where 1 is the lowest rating and 5 is the highest rating. A customer may provide a rating 4 out of 5 which may reflect that the customer was satisfied with how the call center agent handled the call. Here, a higher feedback rating contributes to a higher value of the second interaction score than a lower feedback rating.

In an exemplary scenario, where the first interaction score for an interaction is 2.55, feedback weightage (x, y) is 70% and 30% respectively, and the feedback rating is 4 (out of 5), the second interaction score is calculated as:

Second interaction score=[70%*2.55]+[30%*4]=2.985

In step 208, the processor may determine a third interaction score based on the second interaction score and a time interval between the interaction and a previous interaction between the utility providing entity and the customer entity. Here, the third interaction score is determined by calculating a percentage of the second interaction score. The percentage may be calculated based on a repeated interaction weightage which is further determined based on a time interval between the interaction and the previous similar interaction between the utility providing entity and the customer entity. Here, the repeated interaction weightage is based on time duration between the current interaction and a previously occurred interaction that had a similar specific purpose as the current interaction. In some embodiments, the third interaction score may be calculated by using the mathematical formula:

Third interaction score=z%*(second interaction score)

Here, z is called a repeated interaction weightage that is determined based on a time interval between the interaction for which the third interaction score is being calculated and a previous interaction having a similar specific context. For example, if the current interaction (for which the third interaction score is being calculated) includes a complaint regarding a sewage issue, the processor calculates a time interval between this interaction and a previous interaction that included a complaint regarding a sewage issue by the same customer. Based on time interval i.e., the number of days, the processor determines a value of z by using table 4 below. Table 4 below illustrates a mapping between the time interval between two similar interactions and the repeated interaction weightage.

TABLE 4
Mapping between time interval and repeated interaction weightage

| Time interval | Repeated interaction |
|---|---|
| (no. of days) | weightage |
| 6 to 10 | 55% |
| 10 to 15 | 60% |
| 16 to 20 | 65% |
| 21 to 25 | 70% |
| 26 to 30 | 75% |
| 31 to 35 | 85% |
| 36 to 40 | 90% |
| 41 to 60 | 95% |
| above 60 | 100% |

In an exemplary scenario, where the second interaction score is 2.985 and a time interval between two similar interactions is 37 days, the processor may determine the repeated interaction weightage (z)=90%. Here, the value of the third interaction score may be calculated as:

Third interaction score=90%*(2.985)=2.686

In the above scenario, the third interaction score decreases as compared to the second interaction score because a same interaction has been repeated, thus, indicating that an issue was not permanently resolved during the previous instance. On the contrary, if there is no repetition in an interaction or a repetition occurs after a large time interval, i.e., an interaction or if the repetition has occurred after 60 days, the third interaction score would not decrease as compared to the second interaction score because the repeated interaction weightage would be 100%. Thus, a higher repeated interaction weightage would result in a higher third interaction score.

Once the third interaction score is determined by the processor, the processor may further determine a customer experience score associated with the interaction based on the third interaction score and a stored customer experience score associated with the previous interaction, in step 210. This may include determining weighted summation of the third interaction score and the stored customer experience score associated with the previous interaction, according to the interaction age weightage. The interaction age weightage may be calculated based on a time interval between the current interaction and a previous interaction. The previous interaction may or may not have the same specific purpose as the current interaction. Therefore, the interaction age weightage here for a particular interaction category may or may not be same as a repeated interaction weightage for that category. The customer experience score may be calculated by using the mathematical formula illustrated below:

Customer experience score=[a%*(previous customer experience score)]+[b%*(third interaction score)]

Here, the interaction age weightage (a, b) may define the weights of the third interaction score and the stored customer experience when summing them with each other to calculate the customer experience score. The interaction age weightage may be determined based on the time duration between the current interaction and the previous interaction with the same customer. An exemplary look up table 5 that represents a list of interaction age weightages is illustrated below:

TABLE 5
Interaction age weightage

| | |
|---|---|
| | Interaction age |
| Time interval | weightage |

| (no. of days) | Value of a | Value of b |
|---|---|---|
| 0 to 20 | 40 | 60 |
| 21 to 40 | 50 | 50 |
| 41 to 60 | 60 | 40 |
| 61 to 80 | 70 | 30 |
| above 81 | 80 | 20 |

Further, the previous customer experience score is a customer experience score that was calculated for the previous interaction with the same customer. In some embodiments, the previous interaction may be the most recent interaction with the customer which may have either the same or a different specific purpose as compared to the current interaction. The customer experience scores for various previous interactions may have been stored in the memory. In some embodiments, these scores may have been calculated by using the same method as used for the calculating the customer experience score for the current interaction. In some embodiments, however, if there is no customer experience score available for a previous interaction or the most recent interaction occurred a long time back (e.g. 150 days back) from the current interaction, the processor may assign a default value to the previous customer experience score. For example, the processor may assign the value 4 to the customer experience score in such a case, when a customer experience score is rated out of 5.

In an exemplary scenario, where the third interaction score for an interaction is 2.686 and the previous interaction occurred 30 days before this interaction, the interaction age weightage i.e., the values of a and b may be 50% each (from table 5). Here, a stored customer experience score for the most recent interaction that occurred 30 days before may be 4. In this scenario, the customer experience score may be calculated as:

Customer experience score=[50%*(4)]+[50%*(2.686)]=3.383

This customer experience for the current interaction is rated 3.383 out 5 by the processor.

In step 212, the processor may store the determined customer experience score or provide it to an operator associated with the water utility providing entity. In some embodiments, the processor may provide additional information regarding the nature or type of interactions in a particular range of customer experience score to an operator in the water utility entity based on an exemplary table 6 below:

TABLE 6
Customer experience score and additional information

| Customer experience | Additional Information about nature of |
|---|---|
| score | interactions |
| 4.501 to 5.000 | Contacted for making payments or desirable |
| | reasons and providing very good feedback |
| 3.501 to 4.500 | Did not have any need to contact, contacted for a |
| | request, or contact handled with average or good |
| | feedback |
| 2.501 to 3.500 | Complained regarding relatively less serious |
| | issues, complaints handled well by an agent |
| | leading to good feedback, or a repeated |
| | interaction |
| 1.501 to 2.500 | Contacted for service failures, not handled very |
| | well, or repeated issues |
| 0 to 1.500 | Contacted only for complaints, very poorly |
| | handled, repeated complaints, or escalated |
| | complaints |

It should be apparent, however, that table 6 is illustrated only for exemplary purposes and other additional information may also be provided by the processor than what is specified here. Further, the range of customer experience score may also be different than that specified in table 6.

In an exemplary scenario pertaining to the method illustrated in FIG. 2, a customer may call a water utility entity to register a complaint against a sewage leakage issue near the customer's house. The call may be received by an IVR system in the water utility, which may further redirect the call to a call center agent to register the complaint of the customer. Further, after the call, the customer may provide a feedback rating 4 out of 5 to the performance of the call center agent in handling the call. On analyzing the call with the customer, the call center agent or another assigned user in the water utility entity may determine one or more interaction parameters associated with the interaction of the customer with the water utility entity. Here, the determined interaction parameters include an interaction category: waste water issues and may be determined based on the purpose of the interaction. Further, the interaction parameters may include an interaction sub-category: complaint, an interaction mode: telephonic, and a specific context of the interaction—sewage flooding. All of these interaction parameters may be provided to the processor. The processor may then determine the first interaction score (basic interaction score) for this interaction by using table 2. Here, the basic interaction score for this interaction is 1.

Further, the processor may determine the second interaction score for this interaction by using the mathematic formula for the second interaction score. For the current interaction, the processor determines the second interaction score based on the first interaction score, the feedback rating, and the repeated interaction weightage (which is determined based on the interaction category). Here, the second interaction score may be determined as:

Second interaction score=[(60%*1)+(40%*4)]=2.2

Furthermore, the third interaction score may be determined for this interaction by the processor. Before, the third interaction score is determined, the processor may determine the repeated interaction weightage as 95% based on the time interval between the current interaction and a previous interaction that occurred 50 days before this interaction and included a similar complaint. The third interaction by using the mathematical formula for the third interactions score as follows:

Third interaction score=95%*2.2=2.09

Further, the processor may determine the customer experience score for this interaction. Before determining the customer experience score, the processor may determine that the most recent interaction but having a different purpose than the purpose of the current interaction occurred 22 days before the current interaction Therefore, the interaction age weightage (a, b) from table 5 is 50% each. Further, the customer experience score for the most recent interaction was 4 out of 5. Thus, the customer experience score the current interaction may be determined as follows:

Customer experience score=[(50%*2.09)+(50%*4)]=3.045

This customer experience score when provided to a user or an administrator helps them understand the nature and seriousness of the interaction by using table 6, for example. Further, the customer experience score depends on various factors such as the performance of an agent in handling the call, whether the interaction was a complaint that is treated more seriously than a request, past performance of a water utility in handling customer interactions that is reflected by the customer experience score of the most recent interaction and so on. The customer experience score thus determined, therefore, provides a realistic measure of customer satisfaction. This further helps a water utility in providing better services to customers.

FIG. 2 illustrates a water utility apparatus 300 for determining a customer experience score in accordance with some embodiments. In some embodiments, the water utility apparatus may form a part of the water utility entity such as water utility entity 102. Water utility apparatus 300 may include a processor 302 and a memory 304. Memory 304 of electronic water utility apparatus 300 may include instructions that are executable by processor 302 to determine a customer experience score in accordance with some embodiments of this disclosure.

Processor 302 may receive one or more interaction parameters associated with an interaction between a utility providing entity and a customer entity. Further, processor 302 may determine a first interaction score based on the received one or more interaction parameters. Once the first interaction score is determined, processor 302 may determine a second interaction score based on the first interaction score and a feedback rating associated with the interaction. Further, processor 302 may determine a third interaction score based on the second interaction score and a time interval between the interaction and a previous interaction between the utility providing entity and the customer entity. On determining the third interaction score, processor 302 may determine a customer experience score associated with the interaction based on the third interaction score and a stored customer experience score associated with the previous interaction. Subsequently, processor 302 may provide the determined customer experience score.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for estimating customer experience, the method comprising:
receiving, by a utility providing apparatus, one or more interaction parameters associated with an interaction between a utility providing entity and a customer entity;
determining, by the utility providing apparatus, a first interaction score based on the received one or more interaction parameters;
determining, by the utility providing apparatus, a second interaction score based on the first interaction score and a feedback rating, provided by the customer entity, associated with the interaction;
determining, by the utility providing apparatus, a third interaction score based on the second interaction score and a time interval between the interaction and a previous interaction between the utility providing entity and the customer entity;
determining, by the utility providing apparatus, a customer experience score associated with the interaction based on the third interaction score and a stored customer experience score associated with the previous interaction; and
providing, by the utility providing apparatus, the customer experience score.

2. The method of claim 1, wherein the utility providing entity comprises a water utility providing entity.

3. The method of claim 1, wherein the interaction between the utility providing entity and the customer entity comprises one or more of receiving a written feedback from the customer, a voice call with the customer, a video call with the customer, or receiving an electronic mail from the customer.

4. The method of claim 1, wherein determining the second interaction score comprises:
determining, by the utility providing apparatus, a feedback weightage based on the one or more interaction parameters associated with the interaction; and
determining, by the utility providing apparatus, the second interaction score based on a weighted summation of the first interaction score and the feedback rating according to the feedback weightage.

5. The method of claim 1, wherein determining the third interaction score comprises:
determining, by the utility providing apparatus, a repeated interaction weightage based on the time interval between the interaction and the previous interaction between the utility providing entity and the customer entity; and
determining, by the utility providing apparatus, the third interaction score as a percentage of the second interaction score, wherein the percentage is determined based on the repeated interaction weightage.

6. The method of claim 1, wherein determining the customer experience score comprises:
determining, by the utility providing apparatus, an interaction age weightage based on the one or more interaction parameters associated with the interaction; and
determining, by the utility providing apparatus, the customer experience score based on a weighted summation of the third interaction score and the stored customer experience score associated with the previous interaction, according to the interaction age weightage.

7. A utility providing apparatus comprising:
a processor;
a memory, wherein the memory coupled to the processor which are configured to execute programmed instructions stored in the memory comprising:
receiving one or more interaction parameters associated with an interaction between the utility providing apparatus and a customer entity;
determining a first interaction score based on the received one or more interaction parameters;
determining a second interaction score based on the first interaction score and a feedback rating, provided by the customer entity, associated with the interaction;
determining a third interaction score based on the second interaction score and a time interval between the interaction and a previous interaction between the utility providing entity and the customer entity;
determining a customer experience score associated with the interaction based on the third interaction score and a stored customer experience score associated with the previous interaction; and
providing the customer experience score.

8. The apparatus of claim 7, wherein the utility providing apparatus comprises a water utility providing apparatus.

9. The apparatus of claim 7, wherein the interaction between the utility providing apparatus and the customer entity comprises one or more of receiving a written feedback from the customer, a voice call with the customer, a video call with the customer, or receiving an electronic mail from the customer.

10. The apparatus of claim 7, wherein the processor is further configured to execute programmed instructions stored in the memory further comprising:
determining a feedback weightage based on the one or more interaction parameters associated with the interaction; and
determining the second interaction score based on a weighted summation of the first interaction score and the feedback rating according to the feedback weightage.

11. The apparatus of claim 7, wherein the processor is further configured to execute programmed instructions stored in the memory further comprising:
determining a repeated interaction weightage based on the time interval between the interaction and the previous interaction between the utility providing entity and the customer entity; and
determining the third interaction score as a percentage of the second interaction score, wherein the percentage is determined based on the repeated interaction weightage.

12. The apparatus of claim 7, wherein the processor is further configured to execute programmed instructions stored in the memory further comprising:
determining an interaction age weightage based on the one or more interaction parameters associated with the interaction; and
determining the customer experience score based on a weighted summation of the third interaction score and the stored customer experience score associated with the previous interaction, according to the interaction age weightage.

13. A non-transitory computer readable medium having stored thereon instructions for estimating customer experience comprising machine executable code which when executed by at least one processor, causes the processor to perform steps comprising:
receiving one or more interaction parameters associated with an interaction between a utility providing entity and a customer entity;
determining a first interaction score based on the received one or more interaction parameters;
determining a second interaction score based on the first interaction score and a feedback rating, provided by the customer entity, associated with the interaction;
determining a third interaction score based on the second interaction score and a time interval between the interaction and a previous interaction between the utility providing entity and the customer entity;
determining a customer experience score associated with the interaction based on the third interaction score and a stored customer experience score associated with the previous interaction; and
providing the customer experience score.

14. The medium as set forth in claim 13 wherein the utility providing entity comprises a water utility providing entity.

15. The medium as set forth in claim 13 wherein the interaction between the utility providing entity and the customer entity comprises one or more of receiving a written feedback from the customer, a voice call with the customer, a video call with the customer, or receiving an electronic mail from the customer.

16. The medium as set forth in claim 13, wherein determining the second interaction score comprises:
determining a feedback weightage based on the one or more interaction parameters associated with the interaction; and
determining the second interaction score based on a weighted summation of the first interaction score and the feedback rating according to the feedback weightage.

17. The medium as set forth in claim 13 wherein determining the third interaction score comprises:
determining a repeated interaction weightage based on the time interval between the interaction and the previous interaction between the utility providing entity and the customer entity; and
determining the third interaction score as a percentage of the second interaction score, wherein the percentage is determined based on the repeated interaction weightage.

18. The medium as set forth in claim 13 wherein determining the customer experience score comprises:
determining an interaction age weightage based on the one or more interaction parameters associated with the interaction; and
determining the customer experience score based on a weighted summation of the third interaction score and the stored customer experience score associated with the previous interaction, according to the interaction age weightage.
